(19) United States
(12) Patent Application Publication
(10) Pub. No.: US 2024/0203384 A1
(43) Pub. Date: Jun. 20, 2024

(54) Electronic Devices and Corresponding Methods for Adjusting Playback Characteristics as Audible Alerts

(71) Applicant: Motorola Mobility LLC, Chicago, IL (US)

(72) Inventors: Xiaofeng Zhu, Nanjing (CN); Sanjay Dhar, Algonquin, IL (US)

(21) Appl. No.: 18/095,901

(22) Filed: Jan. 11, 2023

(30) Foreign Application Priority Data
Dec. 15, 2022 (CN) 202211616023.6

(51) Int. Cl. G10H 1/00; G06F 3/16; G08B 3/10

(52) U.S. Cl. CPC G10H 1/0008; G06F 3/165; G08B 3/1008; G10H 2210/341; G10H 2210/391; G10H 2210/555

(57) ABSTRACT

A method in an electronic device includes detecting, by one or more processors of the electronic device, an operating context of the electronic device. The method then alters, by the one or more processors, one or more of a source file of an audio alert or a playback characteristic of the audio alert as a function of the operating context. The altering can eliminate a mismatch between the audible alert and audio content being delivered by an audio output that the audible alert interrupts. The audio output of the electronic device then delivers the audio alert in response to detecting an audio output triggering event.

### CROSS REFERENCE TO PRIOR APPLICATIONS

This application claims priority and benefit under 35 U.S.C. § 119 from Chinese Patent Application No. 202211616023.6, filed Dec. 15, 2022, which is incorporated by reference by rule in accordance with 37 CFR § 1.57.

### BACKGROUND

### Technical Field

This disclosure relates generally to electronic devices having audio output devices, and more particularly to electronic devices implementing and altering electrophonic musical tools as a function of operating conditions of the electronic device and generating and/or outputting ringing tones or other sounds after such alteration.

### Background Art

The technology associated with portable electronic devices, such as smartphones and tablet computers, is continually improving. Illustrating by example, while not too long ago such devices included only grey scale liquid crystal diode displays with large, blocky pixels, modern smartphones, tablet computers, and even smart watches include vivid organic light emitting diode (OLED) displays with incredibly small pixels.

The audio capabilities of these devices have also improved. Despite having small speakers and many design constraints, modern electronic devices are able to operate in “speakerphone” and outer relatively loud audio output operating conditions that allow sound emitted from the electronic device to fill a room with high quality.

Users of such electronic devices frequently take advantage of these improved capabilities to customize their devices. Illustrating by example, ringtones, ringers, and alert notifications allow users to be notified by an (often customized) audible sound when incoming calls, messages, notifications, calendar events, and other communications are received. These ringing tones or other sounds are generally stored in a memory of the electronic device and are pre-configured, using one or more control settings of the electronic device, to be played in response to particular events, examples of which include an incoming calls, incoming notifications, and other events.

In most devices, when such an event occurs and music, sound accompanying video, or other audio content is being emitted by the electronic device, this audio content must be paused so that the alert can be played. It would be advantageous to have improved electronic devices and corresponding methods that improved upon the delivery of audible alerts while audible content is being delivered by an audio output of the electronic device or in response to other factors.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory method in accordance with one or more embodiments of the disclosure.

FIG. 2 illustrates one explanatory electronic device in accordance with one or more embodiments of the disclosure.

FIG. 3 illustrates one or more explanatory audible characteristics of an audible alert that may be adjusted in accordance with one or more embodiments of the disclosure.

FIG. 4 illustrates one or more explanatory trigger events which trigger adjustment of audible characteristics of an audible alert in accordance with one or more embodiments of the disclosure.

FIG. 5 illustrates another explanatory method in accordance with one or more embodiments of the disclosure.

FIG. 7 illustrates one or more embodiments of the disclosure.

FIG. 8 illustrates a prior art method.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to adjusting one or more audible characteristics of an audible alert, which can occur in response to a trigger event, to eliminate a mismatch between the audible alert and other audio content being delivered by an audio output of an electronic device, an operating context of the electronic device, or combinations thereof. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of altering one or more of a source file of an audio alert or audio playback characteristics of the audio alert in as a function of audio content being delivered by an audio output of an electronic device, trigger events, operating contexts of the electronic device, or combinations thereof as described herein. The non-processor circuits may include, but are not limited to, a radio receiver, a radio transmitter, signal drivers, clock circuits, power source circuits, and user input devices. As such, these functions may be interpreted as steps of a method to perform the alteration of the source file and/or audible characteristics of the audible alert.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

As noted above, many electronic devices provide audio output devices capable of employing electrophonic musical tools to generate ringing tones and other sounds. Illustrating by example, ringtones and audible sounds used to indicate alerts, messages, notifications, and the like, can be delivered by an audio output of the electronic device when an incoming call, message, notification, calendar event, or other incoming communication is received. In most cases, those audible alerts are stored in the memory of the electronic device and are pre-configured for particular notification types. For instance, a particular audible alert might notify someone that a text message has been received, while another audible alert might notify the person that a calendar invitation has been received.

Portable electronic communication devices such as smartphones and tablets are being more and more used for content consumption in addition to electronic communications. Illustrating by example, users often employ music playback components, video playback components, gaming components, and so forth to listen to music, watch television, videos, and movies, or play games. Each of these activities generally has audio content associated therewith. When watching a movie, playing a game, or listening to music, an audio output of the electronic device will deliver audio content to an environment around the electronic device. Alternatively, the electronic device may deliver the audio content to another device, such as a pair of headphones or earbuds.

In such conditions, i.e., when audio content is being delivered by an audio output of the electronic device, when an incoming communication, notification, or other event is received that would cause an audible alert to be emitted, the traditional technique of delivering the audible alert is to stop the audio output from delivering the audio content, thereby interrupting the same, and instead deliver the audible alert. Illustrating by example, if a user is using a media player listening to “Innocent When You Dream” by Tom Waits, and a new text message having an audible alert associated with its receipt is received, traditionally the music player will temporarily cease Tom's gravelly crooning, interrupting the same by playing the audible alert. Once the audible alert is complete, the music player may again commence Tom's singing about bats in the belfry and dew on the moor.

Embodiments of the disclosure contemplate that there are various audible characteristics associated with audible alerts delivered by audio outputs of electronic devices. Illustrating by example, a particular audible alert may have basic audible characteristics that affect sound, examples of which include overtones, timbre, pitch, amplitude, duration, melody, harmony, rhythm, texture, and structure or form. The audible characteristics may include expressive characteristics as well, examples of which include dynamics, tempo, and articulation.

Embodiments of the disclosure also contemplate that the audio content that gets interrupted by the audible alert may have other audible characteristics that differ from those of the audible alert. Embodiments of the disclosure contemplate that interrupting audio content having one set of audible characteristics with an audible alert having a completely different set of audible characteristics can be irritating to a user. This is true because start differences in style, key, tempo, or other audible characteristics can be jarring to a user. Someone listening to audio content in the form of Nessun Dorma from Turandot, for example, might be jarred out of their focus if a ringtone having a different style, say a death metal song by Vader, interrupts the aria. Thus, embodiments of the disclosure contemplate that the audible characteristics associated with the audible alert may conflict with other audible characteristics of the audio content being delivered by the audio output. To many people this can be a problem.

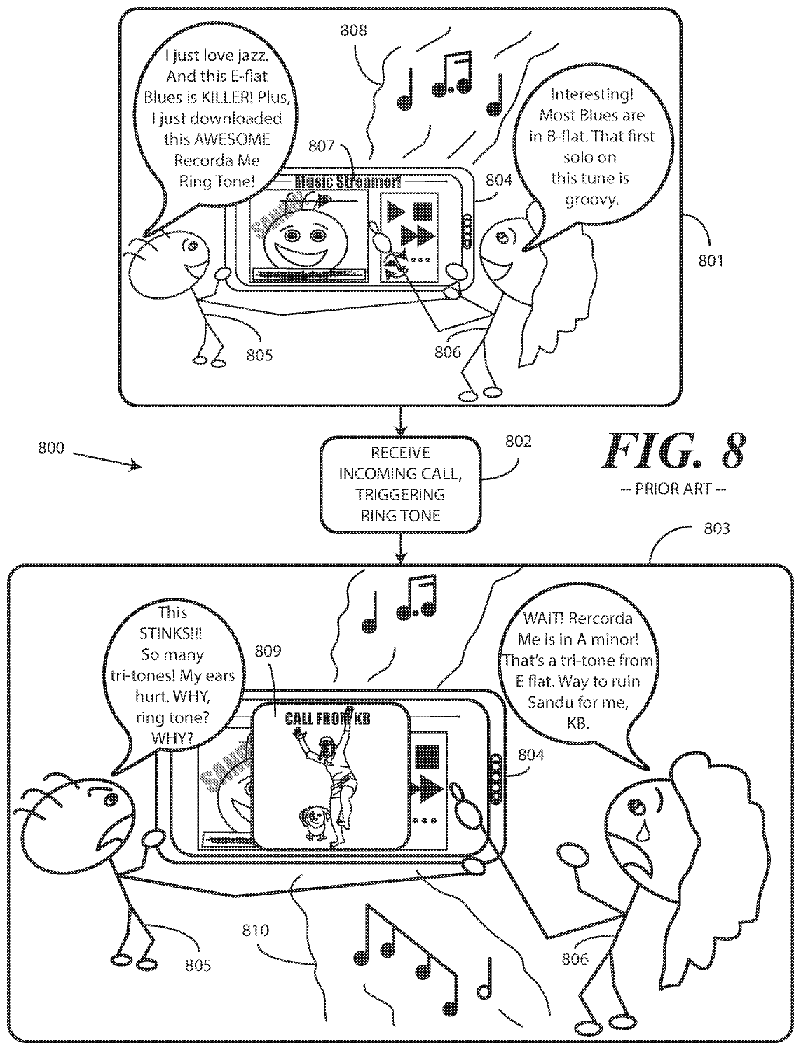

This problem is illustrated in FIG. 8. Turning now to FIG. 8, illustrated therein is a prior art method 800 where an audible alert 810 having audible characteristics different from the audio content 808 it interrupts is delivered by an audio output of an electronic device 804.

Beginning at step 801, an authorized user 805 of the electronic device 804 and a friend 806 of the authorized user 805 are using a music player application 807 to listen to music in the form of audio content 808 being delivered by an audio output of the electronic device 804. In this illustrative example, the audio content 808 is the song “Sandu” by Clifford Brown, as both the authorized user 805 and the friend 806 of the authorized user 805 are jazz fans.

At step 801, both the authorized user 805 and the friend 806 of the authorized user 805 are enjoying the audio content 808 immensely. As shown, the authorized user 805 remarks how much he loves this tune because it is an atypical blues due to the fact that it was written in (and is generally played) in E-flat. The friend 806 agrees, noting that most blues are in B-flat or another common key such as F major.

While listening to Sandu, the authorized user 805 of the electronic device remarks that he has just downloaded a new “jazzy” ringtone. In particular, he has downloaded a ringtone that plays the jazz standard “Recorda Me” by Joe Henderson. Recorda Me, well known to jazz fans, is played over a bossa nova rhythm. One characteristic about Recorda Me is that it is written (and is generally played) in A minor.

As music theorists will appreciate, A minor is a “tritone” away from E-flat. A “tritone” occurs when two tones are six half-steps away from each other. One of the most dissonant sounds in western music, and sometimes called the “devil's interval,” this interval was banned from being played in houses of worship for many, many years, which is one reason thatjazz music developed largely outside of the church. The tritone is so dissonant, that it is even rumored that Mozart's father—to wake Mozart in the morning—would play a piece of music and finish with a chord hanging in the air with a tritone without resolving that tension to a major chord a major fifth away. This would drive Mozart's ears so crazy that he could no longer sleep. Instead, he had to get out of bed, run to the piano, and play that major chord to resolve the devil's interval his father left hanging.

Returning to the method 800 of FIG. 8, at step 802 an event 809 triggering an audible alert 810 is received while the audio output of the electronic device is delivering the audio content 808. In this example, the event 809 triggering the audible alert 810 is that of an incoming call from KB, who is another friend of the authorized user 805 of the electronic device 804. Knowing that KB is a fan of jazz, the authorized user 805 of the electronic device 804 has configured the electronic device 804 such that when KB calls, the audible alert 810 that is triggered is the new Recorda Me ringtone.

As shown at step 803, in one or more embodiments this event 809 triggers the audible alert 810, which is delivered by the audio output of the electronic device 804 as an interruption of the audio content 808. However, as noted above, in some situations this delivery of the audio content 808 and the audible alert 810 can create problems.

In this example, since Sandu and Recorda Me are a tritone apart, a lot of the devil's intervals hit the ears of the listener as Sandu stops and Recorda Me begins. Additionally, the style and form change from a 12-bar blues to a 16-bar bossa. The tempos change, as do the instruments, artists, and numerous other audible characteristics that differ between Sandu and Recorda Me.

As shown at step 803, neither the authorized user 805 of the electronic device 804 nor his friend 806 enjoying the experience. Their comments confirm this fact, as the authorized user 805 of the electronic device 804 complains about his ears hurting due to the tritone change in audible characteristics while his friend 806 remarks that Sandu has been irrevocably tainted. Embodiments of the disclosure contemplate that listening to the Joe Henderson recording from the album Page One will bring her back into the fold.

Advantageously, embodiments of the disclosure provide solutions to the problems shown in FIG. 8. Embodiments of the disclosure provide methods and electronic devices that allow audio content and audible alerts to be played in succession without the issues depicted in FIG. 8 arising.

In one or more embodiments, in response to one or more processors of an electronic device detecting an event triggering an audible alert while audio content is being delivered by an audio output of the electronic device, the one or more processors determine whether there is a mismatch between at least one audible characteristic of the audible alert and at least one other audible characteristic of the audio content. When this occurs, the one or more processors adjust one or more of a source file of the audible alert or a playback characteristic of the audible alert to eliminate the mismatch.

Continuing the example from FIG. 8, using this advanced feature offered by embodiments of the disclosure, the one or more processors of the electronic device my transpose Recorda Me to E-flat, thereby eliminating all the tritone sound differences in one or more embodiments. Thereafter, the one or more processors may cause the audio output of the electronic device to deliver the audible alert. In the example of FIG. 8, this would result in both tunes being delivered in E-flat. Other audible characteristics could be changed as well. Recorda Me may be changed to a blues feel rather than a bossa, for example. This makes the interruption of the audio content less jarring and more pleasant to everyone listening.

Thus, in one or more embodiments audible alerts are played back in a more intelligent manner so as to follow or harmonize with the audio content the audible alert interrupts. Advantageously, even when the audio content is interrupted to allow the audible alert to play, this adjustment of the at least one audible characteristic associated with the audible alert allows the audible alert to “smartly” follow the music it interrupts.

Illustrating by example, if audio content being delivered by an audio output of an electronic device is in the key of C major, but the audible alert is in the key of B-flat major, in one or more embodiments the audible alert will be transposed to C major for playback, which makes the interruption of the C major audio content less abrupt than if the audible alert was played in B-flat. In this manner, the transition between audio content to audible alert and back to audio content is smoother and more harmonious to the ears of a user.

In one or more embodiments, the transition of audible characteristics in an audible alert to match—or mismatch—the audible characteristic of audio content is user definable. While embodiments of the disclosure contemplate that most users will prefer a smooth and harmonious transition between audio content and audible alert, such as when the key of the audible alert is transposed to match the key of the audio content, other users may prefer a more “disruptive” and attention getting transition between audio content and audible alert. Continuing the example from FIG. 8 above, rather than changing Recorda Me from a bossa to a blues, a person may desire to transition the style away from jazz to make the transition more disruptive. Accordingly, they may employ user settings to cause the style of Recorda Me to transition from bossa to death metal so as to be more of an “attention getter.” As such, in one or more embodiments user settings can be used to define how the audible characteristic of the audible alert are adjusted relative to the audible characteristic of the audio content.

In one or more embodiments, an electronic device comprises an audio output and one or more processors operable with the audio output. In one or more embodiments, in response to the one or more processors detecting a trigger event occurring while the audio output delivers audio content, the one or more processors adjust an audible characteristic of an audible alert that is different from another audible characteristic of the audio content prior to causing the audio output to deliver the audible alert. In one or more embodiments, this adjustment occurs automatically and makes the transition from audio content to audible alert smoother and more pleasant by eliminating one or more mismatches between the audible characteristics of the audio content and the audible characteristics of the audible alert. For instance, the one or more processors may adjust the key of a ringtone to match the key of the music it interrupts. The one or more processors may adjust the tempo (frequently measured in beats per minute or “BPM”) of the ringtone as a function of the tempo of the audio content, and so forth.

However, as noted above embodiments of the disclosure contemplate that the purpose of an alert or ringtone is to get the attention of a user. As such, some users may prefer something more disruptive than would be offered by the differences between the audible characteristics of the audio content and the audible characteristics of the audible alert. Accordingly, in one or more embodiments a person can use user settings and controls of the electronic device to determine how the audible characteristics of the audible alert are adjusted relative to the other audible characteristics of the audio content. When listening to Flower by Soshi Takeda, a person may want important calls to be easily identifiable by configuring ringtones as “prog rock” in the style of Dream Theater, and so forth.

The benefit of this “user configurability” compounds when applied to non-“western” music. While a song can have multiple keys where some of them are consonant or dissonant, embodiments of the disclosure contemplate how certain key signatures used in Western music might sound harmonious, but that this might not be always the case. In certain other traditions, scales do not follow certain half steps and are obviously pleasing to the listeners.

In one or more embodiments, the concept of altering the audible characteristics of an audible alert can be extended beyond just basing those changes on the audio content that the audible alert interrupts. Illustrating by example, in other embodiments notification alerts, ringtones, and other audible alerts can be altered in response to operating contexts of the electronic device.

For instance, one or more processors of the electronic device may check the weather to determine whether the electronic device is operating in sunny conditions, rainy conditions, or cloudy conditions. The one or more processors may then adjust the tempo or key of the audible alert as a function of those conditions, with sunny conditions having brighter keys and more upbeat tempos and rainy days having the opposite. If a person is driving a car at a high speed, the tempo of an audible alert may be slowed so as not to distract the driver from the act of driving. If someone calls repeatedly, the tempo of the audible alert may be increased with each repeat call, and so forth. These are just a few operating contexts that can be used to change the audible characteristics of an audible alert. Others will be described below. Still others will be obvious to those of ordinary skill in the art having the benefit of this disclosure.

Thus, in one or more embodiments a method in an electronic device comprises detecting, by one or more processors of the electronic device, an operating context of the electronic device and altering, by the one or more processors, one or more of a source file of an audible alert or a playback characteristic of the audible alert as a function of the operating context. In one or more embodiments, an audible alert then delivers the audible alert in response to detecting an audio output triggering event after the altering. Thus, in one or more embodiments this disclosure relates to electronic devices having audio output devices. In one or more embodiments, the electronic devices configured in accordance with embodiments of the disclosure implement and alter electrophonic musical tools as a function of operating conditions of the electronic device. Thereafter, the electronic devices generate and/or output ringing tones or other sounds.

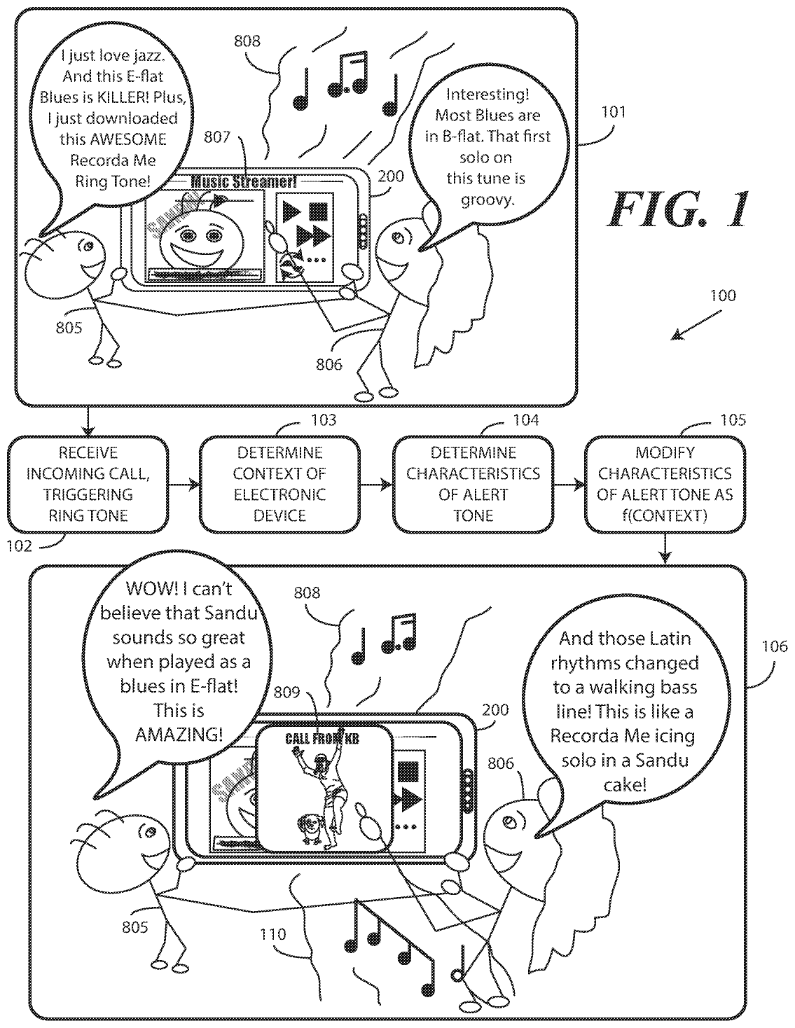

Turning now to FIG. 1, illustrated therein is a method 100 configured in accordance with one or more embodiments of the disclosure that solves the problems illustrated above with reference to FIG. 8. Beginning at step 101, the authorized user 805 of the prior art electronic device (804) of FIG. 8 has upgraded to an electronic device 200 configured in accordance with one or more embodiments of the disclosure, which thrills and delights his friend 806.

Using this new, improved, novel, and non-obvious electronic device 200 and corresponding methods described herein, the authorized user 805 and the friend again use the music player application 807 to listen to music in the form of audio content 808 being delivered by an audio output of the electronic device 804. Once again, the audio content 808 is the song “Sandu” by Clifford Brown.

At step 101, both the authorized user 805 and the friend 806 of the authorized user 805 are again enjoying the audio content 808 immensely. Once again, the authorized user 805 remarks how much he loves this tune because it is an atypical blues due to the fact that it was written in (and is generally played) in E-flat. The friend 806 agrees, noting that most blues are in B-flat or another common key such as F major.

While listening to Sandu, the authorized user 805 of the electronic device again remarks that he has just downloaded a new “jazzy” ringtone that plays the jazz standard “Recorda Me” by Joe Henderson. As previously described, Recorda Me is written (and is generally played) in A minor, which is a tritone away from E-flat.

At step 102, an event 809 triggering an audible alert is received while the audio output of the electronic device is delivering the audio content 808. Once again, the event 809 triggering the audible alert is that of an incoming call from KB. Knowing that KB is a fan of jazz, the authorized user 805 of the electronic device 200 has again configured the electronic device 200 such that when KB calls, the audible alert that is triggered is the new Recorda Me ringtone.

In contrast to the method (800) of FIG. 8, where Recorda Me is played in A minor, in the method 100 of FIG. 1 one or more audible characteristics of the audible alert are adjusted as a function of one or more adjustment factors prior to the audible alert being delivered by the audio output of the electronic device 200. These factors can include audible characteristics of the audio content 808, an operating context of the electronic device 200, a trigger event triggering playback of the audible alert, user settings defined by the authorized user 805 of the electronic device 200, or combinations thereof.

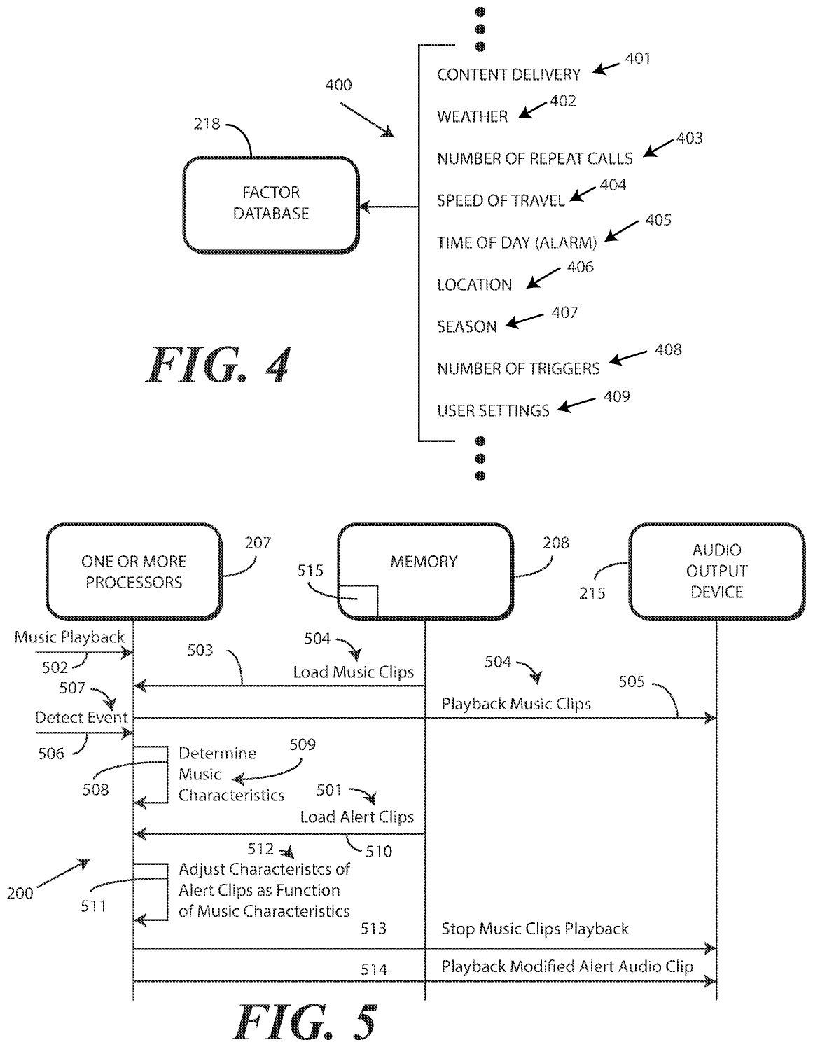

Illustrating by example, at step 103 one or more sensors of the electronic device 200 determine an operating context of the electronic device. Examples of operating contexts include audible characteristics of audio content being delivered by an audio output of the electronic device, a weather condition occurring within an environment of the electronic device, the velocity of movement of the electronic device, a recurrence of incoming calls from a single source being received by a communication device of the electronic device, an identity of a source of an incoming call received by a communication device of the electronic device, and so forth. Other examples of operating contexts will be described below with reference to FIG. 4. Still others will be obvious to those of ordinary skill in the art having the benefit of this disclosure.

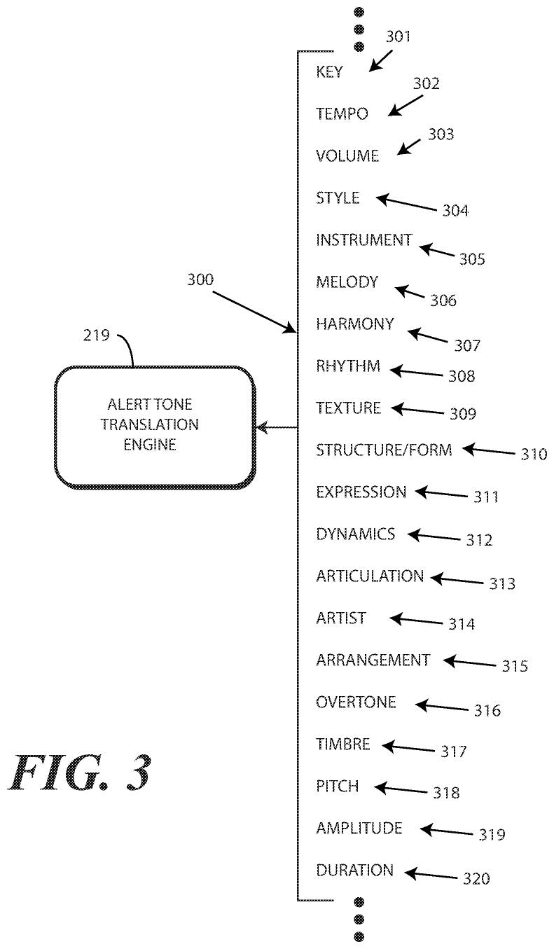

At step 104, one or more processors of the electronic device 200 determine one or more audible characteristics of the audible alert to be delivered by the trigger detected at step 102. Examples of audible characteristics of the audible alert include the key of the audible alert, the various key centers of the audible alert, the tempo of the audible alert, the style of the audible alert, the rhythm of the audible alert, and so forth. Other examples of operating contexts will be described below with reference to FIG. 3. Still others will be obvious to those of ordinary skill in the art having the benefit of this disclosure.

At step 105, the one or more processors of the electronic device 200 adjust one or more of a source file of the audible alert or a playback characteristic of the audible alert. Illustrating by example, if the audible alert is configured as a musical instrument digital interface (MIDI) file, the one or more processors may adjust that source file to change how the audible alert is delivered. By contrast, if the audible alert is stored as a .mp3 or .wav file, the one or more processors may adjust the playback characteristics of the audible alert, either digitally or via analog, when the audible alert is being played back.

In one or more embodiments, step 105 comprises the one or more processors adjusting the source file or playback characteristic of the audible alert to eliminate mismatches between the audible characteristics of the audio content 808 and other audible characteristics of the audible alert that would exist if the audible alert was played back normally. Accordingly, if the audible alert is Recorda Me, the one or more processors of the electronic device 200 may adjust the key by transposing the Recorda Me audible alert from A minor to E-flat to eliminate the mismatch in key occurring between Recorda Me and Sandu.

In other embodiments, the one or more processors may adjust an audible characteristic of the audible alert as a function of the operating context of the electronic device 200. Illustrating by example, if it is raining, the one or more processors may cause the tempo of Recorda Me to slow down. If it is sunny, the tempo may be increased, and so forth.

In still other embodiments, the one or more processors may adjust the audio content of the audible alert as a function of the trigger event detected at step 102. If the trigger event is an incoming phone call, Recorda Me may be played as a waltz. By contrast, if the trigger event is an incoming text message, Recorda Me may be played as a ska shuffle.

In still other embodiments, the one or more processors can adjust the audible characteristics of the audible alert as a function of user settings. As noted above, the purpose of an alert or ringtone is to get the attention of a user. As such, some users may prefer something more disruptive than would be offered by the differences between the audible characteristics of the audio content 808 and the audible characteristics of the audible alert. Accordingly, in one or more embodiments a person can use user settings and controls of the electronic device 200 to determine how the audible characteristics of the audible alert are adjusted relative to the other audible characteristics of the audio content 808. Since both Sandu and Recorda Me are jazz standards, a person may want important calls such as those from KB to be easily identifiable by making Recorda Me a thumping hip-hop rap anthem instead, and so forth.

At step 106, the one or more processors of the electronic device 200 cause the audio output of the electronic device to interrupt the audio content 808 and play the adjusted audible alert 110. In this illustrative example, the one or more processors have adjusted Recorda Me to eliminate a mismatch between it and the audio content 808 defined by Sandu by changing the key of Recorda Me to E-flat at step 105. Additionally, the one or more processors have changed the style of Recorda Me from a bossa to a swing tune having a walking bass line similar to that found in a jazz blues.

At step 106, the audio output of the electronic device 200 interrupts Sandu and delivers this adjusted audible alert 110 to the surprise and delight of both the authorized user 805 of the electronic device 200 and his friend. Both are shocked and beyond impressed, with the authorized user 805 remarking not only how good Recorda Me sounds in E-flat. His friend 806 notes how delightful the melody sounds over a walking bass line that is similar to that of Sandu. Accordingly, the method 100 of FIG. 1 has caused the transition between the audio content 808, Sandu, and the adjusted audible alert 110, Recorda Me, to be smoother, less jarring, less abrupt, and more aurally pleasing. Advantageously, when the adjusted audible alert 110 ends and the audio content 808 returns, it is easier for the authorized user 805 and his friend 806 to fall back into the killer Clifford Brown solo on Sandu that is one of the best in jazz.

Advantageously, the method 100 of FIG. 1 provides solutions to the problems shown in FIG. 8. The method 100 of FIG. 1 allows audio content 808 and adjusted audible alerts 110 to be played in succession without the issues depicted in FIG. 8 arising.

In one or more embodiments, in response to one or more processors of an electronic device 200 detecting an event triggering an audible alert while audio content 808 is being delivered by an audio output of the electronic device 200, the one or more processors determine whether there is a mismatch between at least one audible characteristic of the audible alert and at least one other audible characteristic of the audio content 808. When this occurs, the one or more processors adjust one or more of a source file of the audible alert or a playback characteristic of the audible alert to eliminate the mismatch.

As shown in FIG. 1, using this advanced feature offered by embodiments of the disclosure, the one or more processors of the electronic device 200 transpose Recorda Me to E-flat, thereby eliminating all the tritone sound differences between the audio content 808 and the adjusted audible alert 110. The one or more processors change the style of Recorda Me as well. Thereafter, the one or more processors may cause the audio output of the electronic device 200 to deliver the adjusted audible alert 110. In the example of FIG. 1, this results in both tunes being delivered in E-flat and in a similar style. Other audible characteristics could be changed as well. Recorda Me may be changed from the melody sounding like a saxophone (Joe Henderson) to the melody sounding like a trumpet (Clifford Brown), for example. This makes the interruption of the audio content less jarring and more pleasant to everyone listening.

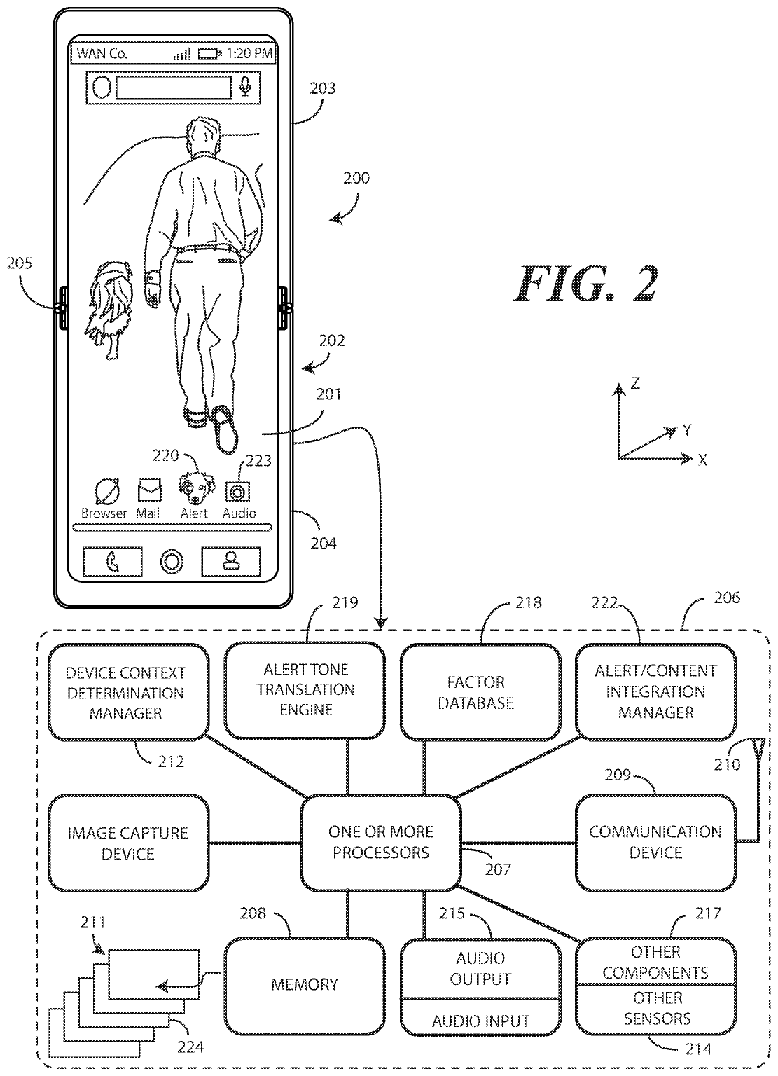

Turning now to FIG. 2, illustrated therein is one explanatory electronic device 200 configured in accordance with one or more embodiments of the disclosure. The electronic device 200 of FIG. 2 is a portable electronic device and is shown as a smartphone for illustrative purposes. However, it should be obvious to those of ordinary skill in the art having the benefit of this disclosure that other electronic devices may be substituted for the explanatory smart phone of FIG. 2. For example, the electronic device 200 could equally be a conventional desktop computer, palm-top computer, a tablet computer, a gaming device, a media player, or other device.

This illustrative electronic device 200 includes a display 201, which may optionally be touch sensitive. Users can deliver user input to the display 201, which serves as a user interface for the electronic device 200. In one embodiment, users can deliver user input to the display 201 of such an embodiment by delivering touch input from a finger, stylus, or other objects disposed proximately with the display 201. In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 200 of FIG. 2 also includes a device housing 202. In one embodiment, the device housing 202 includes two housing members, namely, a first device housing 203 that is coupled to a second device housing 204 by a hinge 205 such that the first device housing 203 is pivotable about the hinge 205 relative to the second device housing 204 between a closed position and an axially displaced open position. In other embodiments, such as that associated with the electronic device (200) of FIG. 1, the device housing 202 will be rigid and will include no hinge.

In still other embodiments, the device housing 202 will be manufactured from a flexible material such that it can be bent and deformed. Where the device housing 202 is manufactured from a flexible material or where the device housing 202 includes a hinge, the display 201 can be manufactured on a flexible substrate such that it bends. In one or more embodiments, the display 201 is configured as a flexible display that is coupled to the first device housing 203 and the second device housing 204, spanning the hinge 205. Features can be incorporated into the device housing 202, including control devices, connectors, and so forth.

Also shown in FIG. 2 is an explanatory block diagram schematic 206 of the explanatory electronic device 200. In one or more embodiments, the block diagram schematic 206 is configured as a printed circuit board assembly disposed within the device housing 202 of the electronic device 200. Various components can be electrically coupled together by conductors, or a bus disposed along one or more printed circuit boards.

The illustrative block diagram schematic 206 of FIG. 2 includes many different components. Embodiments of the disclosure contemplate that the number and arrangement of such components can change depending on the particular application. Accordingly, electronic devices configured in accordance with embodiments of the disclosure can include some components that are not shown in FIG. 2, and other components that are shown may not be needed and can therefore be omitted.

In one embodiment, the electronic device includes one or more processors 207. In one embodiment, the one or more processors 207 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the block diagram schematic 206. Each of the application processor and the auxiliary processor(s) can be configured to process and execute executable software code to perform the various functions of the electronic device with which the block diagram schematic 206 operates. A storage device, such as memory 208, can optionally store the executable software code used by the one or more processors 207 during operation.

In this illustrative embodiment, the block diagram schematic 206 also includes a communication device 209 that can be configured for wired or wireless communication with one or more other devices or networks. The networks can include a wide area network, a local area network, and/or personal area network. The communication device 209 may also utilize wireless technology for communication, such as, but are not limited to, peer-to-peer or ad hoc communications such as HomeRF, Bluetooth and IEEE 802.11, and other forms of wireless communication such as infrared technology. The communication device 209 can include wireless communication circuitry, one of a receiver, a transmitter, or transceiver, and one or more antennas 210.

In one embodiment, the one or more processors 207 can be responsible for performing the primary functions of the electronic device with which the block diagram schematic 206 is operational. For example, in one embodiment the one or more processors 207 comprise one or more circuits operable with the display 201 to present presentation information to a user. The executable software code used by the one or more processors 207 can be configured as one or more modules 211 that are operable with the one or more processors 207. Such modules 211 can store instructions, control algorithms, and so forth. This executable software code can be configured as an alert tone adjustment application 220, an audio output application 223, or other applications.

In one or more embodiments, the alert tone adjustment application 220 allows user settings to be defined instructing how the audible characteristic of the audible alert is adjusted relative to the audible characteristic of the audio content or other factors. In one or more embodiments, a user can use the alert tone adjustment application 220 and its associated controls to determine how the audible characteristics of the audible alert are adjusted relative to the other audible characteristics audio content delivered by an audio output of the electronic device 200 in response to the audio output application 223. When listening to Je Suis un Rockstar by Rolling Stones legend Bill Wyman, a person may want important calls to be easily identifiable by configuring ringtones as “clanging and crooning” in the style of minimalist Deacon Lunchbox, and so forth.

In one embodiment, the one or more processors 207 are responsible for running the operating system environment of the electronic device 200. The operating system environment can include a kernel and one or more drivers, and an application service layer, and an application layer. The operating system environment can be configured as executable code operating on one or more processors or control circuits of the electronic device 200. The application layer can be responsible for executing application service modules. The application service modules may support one or more applications or “apps,” such as the alert tone adjustment application 220 or audio output application 223.

The applications of the application layer can be configured as clients of the application service layer to communicate with services through application program interfaces (APIs), messages, events, or other inter-process communication interfaces. Where auxiliary processors are used, they can be used to execute input/output functions, actuate user feedback devices, and so forth.

In one embodiment, the one or more processors 207 may generate commands or execute control operations based upon user input received at the user interface. Moreover, the one or more processors 207 may process the received information alone or in combination with other data, such as the information stored in the memory 208.

Various sensors 214 can be operable with the one or more processors 207. One example of a sensor that can be included with the various sensors 214 is a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 207, to detect an object in close proximity with—or touching—the surface of the display 201 or the device housing 202 of the electronic device 200 by establishing electric field lines between pairs of capacitive sensors and then detecting perturbations of those field lines.

Another example of a sensor that can be included with the various sensors 214 is a geo-locator that serves as a location detector. In one embodiment, location detector determines location data. Location can be determined by capturing the location data from a constellation of one or more earth orbiting satellites, or from a network of terrestrial base stations to determine an approximate location. The location detector may also be able to determine location by locating or triangulating terrestrial base stations of a traditional cellular network, or from other local area networks, such as Wi-Fi networks.

Another example of a sensor that can be included with the various sensors 214 is an orientation detector operable to determine an orientation and/or movement of the electronic device 200 in three-dimensional space. Illustrating by example, the orientation detector can include an accelerometer, gyroscopes, or other device to detect device orientation and/or motion of the electronic device 200. Using an accelerometer as an example, an accelerometer can be included to detect motion of the electronic device. Additionally, the accelerometer can be used to sense some of the gestures of the user, such as one talking with their hands, running, or walking.

The orientation detector can determine the spatial orientation of an electronic device 200 in three-dimensional space by, for example, detecting a gravitational direction. In addition to, or instead of, an accelerometer, an electronic compass can be included to detect the spatial orientation of the electronic device 200 relative to the earth's magnetic field. Similarly, one or more gyroscopes can be included to detect rotational orientation of the electronic device 200.

Other components 217 operable with the one or more processors 207 can include output components such as video outputs, audio outputs 215, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio outputs 215 such as a loudspeaker disposed behind a speaker port or other alarms and/or buzzers and/or a mechanical output component such as vibrating or motion-based mechanisms.

The other components 217 can also include proximity sensors. The proximity sensors fall in to one of two camps: active proximity sensors and “passive” proximity sensors. Either the proximity detector components or the proximity sensor components can be generally used for gesture control and other user interface protocols.

The other components 217 can optionally include a barometer operable to sense changes in air pressure due to elevation changes or differing pressures of the electronic device 200. The other components 217 can also optionally include a light sensor that detects changes in optical intensity, color, light, or shadow in the environment of an electronic device. This can be used to make inferences about operating contexts of the electronic device 200 such as weather or colors, walls, fields, and so forth, or other cues.

An infrared sensor can be used in conjunction with, or in place of, the light sensor. The infrared sensor can be configured to detect thermal emissions from an environment about the electronic device 200. Similarly, a temperature sensor can be configured to monitor temperature about an electronic device.

A device context determination manager 212 can then be operable with the various sensors 214 to detect, infer, capture, and otherwise determine persons and actions that are occurring in an environment about the electronic device 200. For example, where included one embodiment of the device context determination manager 212 determines assessed contexts and frameworks using adjustable algorithms of context assessment employing information, data, and events. These assessments may be learned through repetitive data analysis. Alternatively, a user may employ a menu or user controls via the display 201 to enter various parameters, constructs, rules, and/or paradigms that instruct or otherwise guide the device context determination manager 212 in determining operating context that can be used as inputs for an alert tone translation engine 219 that adjusts one or more audible characteristics of an alert tone as a function of one or more factors, examples of which will be described below with reference to FIG. 4. These factors can further include multi-modal social cues, emotional states, moods, and other contextual information identified by the device context determination manager 212. The device context determination manager 212 can comprise an artificial neural network or other similar technology in one or more embodiments.

In one or more embodiments, the electronic device 200 includes a device context determination manager 212. In one or more embodiments, the device context determination manager 212 is operable to determine an operating context of the electronic device 200. Thereafter, an alert tone translation engine 219 is operable to alter one or more of a source file 224 of an audible alert or a playback characteristic of the audible alert as a function of the operating context identified by the device context determination manager 212.

Examples of the operating context can vary. In one or more embodiments, the operating context comprises audio output being delivered by the audio output 215 of the electronic device 200 when a trigger event triggering playback of the audible alert is received. Such an example was described above with reference to FIG. 1 where an incoming call from KB was received, triggering the playback of Recorda Me, while the audio output 215 was delivering audio content in the form of Sandu. Accordingly, in one or more embodiments the operating context detected by the device context determination manager 212 comprises audio content being delivered by the audio output 215 of the electronic device 200.

In other embodiments, the operating context detected by the device context determination manager 212 comprises a weather condition sensed by the one or more sensors 214. In still other embodiments, the operating context detected by the device context determination manager 212 comprises a velocity of movement of the electronic device 200 sensed by the one or more sensors 214.

In other embodiments, the operating context detected by the device context determination manager 212 comprises a number of recurrences of an incoming communication received by the communication device 209. In still other embodiments, the operating context detected by the device context determination manager 212 comprises an identity of a source of an incoming call received by the communication device 209. Other operating contexts will be described below. Still others will be obvious to those of ordinary skill in the art having the benefit of this disclosure.

The device context determination manager 212 can be operable with a factor database 218. In one or more embodiments, the factor database 218 stores one or more factors that serve as inputs for an audible alert adjustment function applied by the alert tone translation engine 219. In one or more embodiments, the factor database 218 stores one or more factors that, when detected by the device context determination manager 212, cause the alert tone translation engine 219 to adjust one or more audible characteristics of an audible alert.

Turning briefly to FIG. 4, illustrated therein are some explanatory examples of factors that can be stored in the factor database 218. It should be noted that these factors are illustrative only, as others will be obvious to those of ordinary skill in the art having the benefit of this disclosure.

In one or more embodiments, a factor 401 that can cause the alert tone translation engine (219) to adjust one or more audible characteristics of an audible alert is content delivery. As noted above, in one or more embodiments one or more processors (207) of an electronic device (200 detect an event triggering the audible alert occurring while audio content is being delivered by the audio output (215) of the electronic device (200). This audio content can be a factor 401 used to alter the audible characteristics of an audible alert. For instance, in one or more embodiments one or more processors (207) of the electronic device (200) determine whether there is a mismatch between the audio content of this factor 401 and at least one other audible characteristic of the audible alert. Where this is the case, this factor 401 can cause the alert tone translation engine (219) to adjust one or more audible characteristics of an audible alert to eliminate the mismatch. Examples of such audible characteristics will be described below with reference to FIG. 3. Still others will be obvious to those of ordinary skill in the art having the benefit of this disclosure.

Another factor 402 stored in the factor database 218 that can cause the alert tone translation engine (219) to adjust one or more audible characteristics of an audible alert is the weather. Illustrating by example, weather conditions of rain, sunshine, clouds, and so forth might cause the alert tone translation engine (219) to adjust one or more audible characteristics of an audible alert by increasing or decreasing the tempo for example as a function of the weather condition.

Another factor 403 stored in the factor database 218 that can cause the alert tone translation engine (219) to adjust one or more audible characteristics of an audible alert is a number of repeat incoming communications from a single source. Illustrating by example, if a person calls the first time, an audible alert may be played back at an original tempo. However, as the same person calls again and again and again, in one or more embodiments this may cause the alert tone translation engine (219) to adjust one or more audible characteristics of an audible alert by increasing the tempo for example with each successive call, thereby aurally alerting a user to the number of times the call from the person has gone unanswered.

Another factor 404 stored in the factor database 218 that can cause the alert tone translation engine (219) to adjust one or more audible characteristics of an audible alert is the velocity of movement of the electronic device (200). Illustrating by example, the speed at which the electronic device (200) is moving may cause the alert tone translation engine (219) to adjust one or more audible characteristics of an audible alert by increasing or decreasing the tempo. If the driver of a car is driving slowly, the tempo of the audible alert might be faster than if the driver is driving rapidly. This slowing of tempo in an inverse relationship to the speed of the vehicle may prevent the driver from being distracted at the higher speeds, which may be beneficial to safety in one or more embodiments.

Another factor 405 stored in the factor database 218 that can cause the alert tone translation engine (219) to adjust one or more audible characteristics of an audible alert is the time of day. Illustrating by example, if an audible alert is set as a morning wake up tone, this can cause the alert tone translation engine (219) to adjust one or more audible characteristics of an audible alert by increasing the tempo or pitch of the audible alert to ensure a person wakes up. By contrast, when playback of an audible alert is required in the evening, this may cause the alert tone translation engine (219) to decrease the tempo or pitch so that a person does not get over stimulated prior to going to bed.

Another factor 406 stored in the factor database 218 that can cause the alert tone translation engine (219) to adjust one or more audible characteristics of an audible alert is the location of the electronic device (200). Illustrating by example, if a person is diligently working at the workplace this can cause the alert tone translation engine (219) to adjust one or more audible characteristics of an audible alert by increasing the tempo to ensure that the user of the electronic device (200) stays on task. By contrast, when the location is a resort location such as may be the case when the person is on vacation, the alert tone translation engine (219) may decrease the tempo to keep the person in their relaxed island vibe.

Another factor 407 stored in the factor database 218 that can cause the alert tone translation engine (219) to adjust one or more audible characteristics of an audible alert is the season. Illustrating by example, spring, summer, winter, and fall, holidays, and so forth might cause the alert tone translation engine (219) to adjust one or more audible characteristics of an audible alert by increasing or decreasing the tempo for example as a function of the user's preferences for that season.

Another factor 408 stored in the factor database 218 that can cause the alert tone translation engine (219) to adjust one or more audible characteristics of an audible alert is the number of triggers for the same event. Illustrating by example, if a person calls once, the audible alert may play normally. However, if the person calls again and again, this might cause the alert tone translation engine (219) to adjust one or more audible characteristics of an audible alert by increasing the tempo.

Still another factor 400 stored in the factor database 218 that can cause the alert tone translation engine (219) to adjust one or more audible characteristics of an audible alert is the user settings 409. Illustrating by example, in one or more embodiments the transition of audible characteristics in an audible alert to match—or mismatch—the audible characteristic of audio content is user definable. While embodiments of the disclosure contemplate that most users will prefer a smooth and harmonious transition between audio content and audible alert, such as when the key of the audible alert is transposed to match the key of the audio content, other users may prefer a more “disruptive” and attention getting transition between audio content and audible alert. Accordingly, they may employ user settings to define how the audible characteristic of the audible alert are adjusted relative to the audible characteristic of the audio content.

As noted above embodiments of the disclosure contemplate that the purpose of an alert or ringtone is to get the attention of a user. As such, some users may prefer something more disruptive than would be offered by the differences between the audible characteristics of the audio content and the audible characteristics of the audible alert. Accordingly, in one or more embodiments a person can use user settings and controls of the electronic device to control how the alert tone translation engine (219) changes audible characteristics of audible alert.

The benefit of this “user configurability” compounds when applied to non-western music. While a song can have multiple keys where some of them are consonant or dissonant, embodiments of the disclosure contemplate how certain key signatures used in Western music might sound harmonious, but that this might not be always the case. In certain other traditions, scales do not follow certain half steps and are obviously pleasing to the listeners.

Turning now back to FIG. 1, the alert tone translation engine 219 can adjust the audible characteristics of audible alerts in a variety of ways in response to the device context determination manager 212 detecting an operating context of the electronic device 200. As noted above, embodiments of the disclosure contemplate that there are various audible characteristics associated with audible alerts delivered by the audio output 215 of the electronic device 200. These can include basic audible characteristics that affect sound, examples of which include overtones, timbre, pitch, amplitude, duration, melody, harmony, rhythm, texture, and structure or form. The audible characteristics may include expressive characteristics as well, examples of which include dynamics, tempo, and articulation. In one or more embodiments, the alert tone translation engine 219 can change one or more of these audible characteristics, alone or in combination, as a function of the factors stored in the factor database 218, operating contexts detected by the device context determination manager 212, or other factors.

Turning briefly to FIG. 3, illustrated therein are examples of audible characteristics 300 that the alert tone translation engine 219 may change in accordance with embodiments of the disclosure. These audible characteristics 300 are illustrative only, as others will be obvious to those of ordinary skill in the art having the benefit of this disclosure.

The audible characteristics 300 can include the key 301 of the audible alert. Illustrating by example, the alert tone translation engine 219 may transpose the key or the key centers (many songs have multiple key centers) from a first key to a second key. In the example illustrated above in FIG. 1, Recorda Me was transposed from A minor to E-flat.

Another example of an audible characteristic 300 that can be changed is the tempo 302. As described above with reference to FIG. 4, the alert tone translation engine 219 can increase or decrease the tempo of an audible alert to match audio content the audible alert interrupts, in response to factors stored in the factor database (218), operating contexts determined by the device context determination manager 212, or other factors.

Another example of an audible characteristic 300 that can be changed is the volume 303. The alert tone translation engine 219 can increase or decrease the volume of an audible alert to match audio content the audible alert interrupts, in response to factors stored in the factor database (218), operating contexts determined by the device context determination manager 212, or other factors.

Another example of an audible characteristic 300 that can be changed is the style 304. As described above with reference to FIG. 1, the alert tone translation engine 219 can change the style of an audible alert, e.g., from bossa to swing, to match audio content the audible alert interrupts, in response to factors stored in the factor database (218), operating contexts determined by the device context determination manager 212, or other factors.

Another example of an audible characteristic 300 that can be changed is the instrument 305 playing the audible alert. As described above with reference to FIG. 1, the alert tone translation engine 219 can change the instrument 305 of an audible alert, e.g., from saxophone to trumpet, to match audio content the audible alert interrupts, in response to factors stored in the factor database (218), operating contexts determined by the device context determination manager 212, or other factors.

Another example of an audible characteristic 300 that can be changed is the melody 306 itself. If, for example, an audible alert is configured as Amazing Grace, in one or more embodiments the alert tone translation engine 219 might change the melody of the audible alert to the theme from Gilligan's Island when a friend calls since these melodies can be interchangeably played over their harmonies. In one or more embodiments, the alert tone translation engine 219 changes the melody 306 to match audio content the audible alert interrupts, in response to factors stored in the factor database (218), operating contexts determined by the device context determination manager 212, or other factors.

Similarly, another example of an audible characteristic 300 that can be changed is the harmony 307. Any number of artists have played melodies over John Coltrane's changes to Giant Steps, including Katy Perry's “Roar.” Accordingly, in one or more embodiments the alert tone translation engine 219 can change the harmony 307 of an audible alert to match audio content the audible alert interrupts, in response to factors stored in the factor database (218), operating contexts determined by the device context determination manager 212, or other factors.

Another example of an audible characteristic 300 that can be changed is the rhythm 308. Returning to Giant Steps, many jazz hipsters at jam sessions like to call this tune in 7/4 rather than the 4/4-time signature in which Coltrane penned the tune, which changes the rhythm 308. Accordingly, in one or more embodiments the alert tone translation engine 219 can change the rhythm 308 of an audible alert to match audio content the audible alert interrupts, in response to factors stored in the factor database (218), operating contexts determined by the device context determination manager 212, or other factors.

Another example of an audible characteristic 300 that can be changed is the texture 309. “Texture” 309 is generally defined as the construct of melody, tempo, and harmony in combination. There are four generally accepted textures 309 in music: monophony, polyphony, homophony, and heterophony. Accordingly, in one or more embodiments t the alert tone translation engine 219 can adjust the texture 309 of an audible alert to match audio content the audible alert interrupts, in response to factors stored in the factor database (218), operating contexts determined by the device context determination manager 212, or other factors.

Another example of an audible characteristic 300 that can be changed is the structure or form 310. Illustrating by example, the structure or form 310 of a 32-bar ballad may be changed to a 16-bar blues played twice. Accordingly, in one or more embodiments the alert tone translation engine 219 can change the structure or form 310 to match audio content the audible alert interrupts, in response to factors stored in the factor database (218), operating contexts determined by the device context determination manager 212, or other factors.

Another example of an audible characteristic 300 that can be changed is the expression 311. While Brad Mehldau often plays “Exit Music (for a film)” or the gloomy and dark “Paranoid Android” by Radiohead on piano, the expression 311 of each is quite different than when Radiohead plays the same tune with the full band. Accordingly, in one or more embodiments the alert tone translation engine 219 can change the expression 311 of an audible alert to match audio content the audible alert interrupts, in response to factors stored in the factor database (218), operating contexts determined by the device context determination manager 212, or other factors.

Another example of an audible characteristic 300 that can be changed are the dynamics 312. Dynamics 312 defined the variation in loudness or softness between phrases and notes in a piece of audible content. Accordingly, in one or more embodiments the alert tone translation engine 219 can increase or decrease the dynamics 312 of an audible alert to match audio content the audible alert interrupts, in response to factors stored in the factor database (218), operating contexts determined by the device context determination manager 212, or other factors.

Another example of an audible characteristic 300 that can be changed is the articulation 313. Articulation 313 comprises the mechanics with which notes or sounds are made in audible content. Illustrating by example, while Neal Pert and Buddy Rich are both epic drummers, each is easily aurally distinguishable from the other due to the articulation 313 with which they use sticks to hit drums. The same is true when comparing Bill Evans to Thelonious Monk. One will never be mistaken for the other due to their very different articulations 313 in pressing the piano keys. Accordingly, in one or more embodiments the alert tone translation engine 219 can change the articulation 313 of an audible alert to match audio content the audible alert interrupts, in response to factors stored in the factor database (218), operating contexts determined by the device context determination manager 212, or other factors.

Another example of an audible characteristic 300 that can be changed is the artist 314. Nobody sounds like Tom Waits. A particular user might like to unwind in the evenings listening to Tom Waits, but may prefer Joe Strummer in the morning. In one or more embodiments, the alert tone translation engine 219 can change the artist 314 of an audible alert to match audio content the audible alert interrupts, in response to factors stored in the factor database (218), operating contexts determined by the device context determination manager 212, or other factors. Who wouldn't like to hear Tom Waits sing “London Calling” ?

Another example of an audible characteristic 300 that can be changed is the arrangement 315. A trio arrangement may be changed to a big band arrangement, and so forth. In one or more embodiments, the alert tone translation engine 219 can change the arrangement 315 of an audible alert to match audio content the audible alert interrupts, in response to factors stored in the factor database (218), operating contexts determined by the device context determination manager 212, or other factors.

Another example of an audible characteristic 300 that can be changed are the overtones 316. Overtones 316 in music are the frequencies that are higher than the fundamental frequencies of a note. Overtones 316 are why a pipe organ sounds different from a harp or bagpipes. Accordingly, in one or more embodiments the alert tone translation engine 219 can change the overtones 316 of an audible alert to match audio content the audible alert interrupts, in response to factors stored in the factor database (218), operating contexts determined by the device context determination manager 212, or other factors.

Another example of an audible characteristic 300 that can be changed is the timbre 317. Timbre 317 in music is the tone or color or quality of a perceived sound. Timbre 317 is how people with perfect pitch distinguish sharps and flats from natural notes. Accordingly, in one or more embodiments the alert tone translation engine 219 can change the timbre 317 of an audible alert to match audio content the audible alert interrupts, in response to factors stored in the factor database (218), operating contexts determined by the device context determination manager 212, or other factors.

Another example of an audible characteristic 300 that can be changed is the pitch 318. In one or more embodiments the alert tone translation engine 219 can change the pitch 318 of an audible alert to match audio content the audible alert interrupts, in response to factors stored in the factor database (218), operating contexts determined by the device context determination manager 212, or other factors.

Another example of an audible characteristic 300 that can be changed is the amplitude 319. In one or more embodiments the alert tone translation engine 219 can change the amplitude 319 of an audible alert to match audio content the audible alert interrupts, in response to factors stored in the factor database (218), operating contexts determined by the device context determination manager 212, or other factors.

Another example of an audible characteristic 300 that can be changed is the duration 320. In one or more embodiments the alert tone translation engine 219 can change the duration 320 of an audible alert to match audio content the audible alert interrupts, in response to factors stored in the factor database (218), operating contexts determined by the device context determination manager 212, or other factors.

Turning now back to FIG. 1, in one or more embodiments the electronic device 200 comprises an alert/content integration manager 222. The alert/content integration manager 222 is an electrophonic musical tool configured to generate and/or output ringing tones and other sounds after the alert tone translation engine 219 alters the same. In one or more embodiments. The alert/content integration manager functions to integrate audible alert into audio content to alert a user to an event.

Illustrating by example, the alert/content integration manager 222 can pause audio content to allow an audible alert to interrupt the audio content in one or more embodiments. In other embodiments, the alert/content integration manager 222 can cause the audible alert to be played simultaneously with the audio content. While many embodiments contemplate audible alerts interrupting audio content, in other embodiments they can be played simultaneously. This works especially well when the alert tone translation engine 219 eliminates mismatches between audible characteristics of the audible alert and other audible characteristics of the audio content.

Continuing the example from FIG. 1 above, using this advanced feature offered by embodiments of the disclosure when the alert/content integration manager 222 plays audio content and audible alerts simultaneously after the alert tone translation engine 219 transposes Recorda Me to E-flat, thereby eliminating all the tritone sounds, this would result in both tunes being delivered in E-flat. Despite Recorda Me being a bossa and Sandu being a blues, this could make for some fun, interesting, and harmonious beats that both allow the people to continue listening to Sandu and still know that an incoming call from KB has been received.

In one or more embodiments, the device context determination manager 212, the alert tone translation engine 219, the alert/content integration manager 222, and the device context determination manager 212 are each operable with the one or more processors 207. In some embodiments, the one or more processors 207 can control the alert tone translation engine 219, the alert/content integration manager 222, and the device context determination manager 212. In other embodiments, the device context determination manager 212, the alert tone translation engine 219, the alert/content integration manager 222, and the device context determination manager 212 can operate independently. The device context determination manager 212, the alert tone translation engine 219, the alert/content integration manager 222, and the device context determination manager 212 can receive data from the various sensors 214. In one or more embodiments, the one or more processors 207 are configured to perform the operations of the device context determination manager 212, the alert tone translation engine 219, the alert/content integration manager 222, and the device context determination manager 212.

It is to be understood that FIG. 2 is provided for illustrative purposes only and for illustrating components of one electronic device 200 in accordance with embodiments of the disclosure and is not intended to be a complete schematic diagram of the various components required for an electronic device. Therefore, other electronic devices configured in accordance with embodiments of the disclosure may include various other components not shown in FIG. 2 or may include a combination of two or more components or a division of a particular component into two or more separate components, and still be within the scope of the present disclosure.

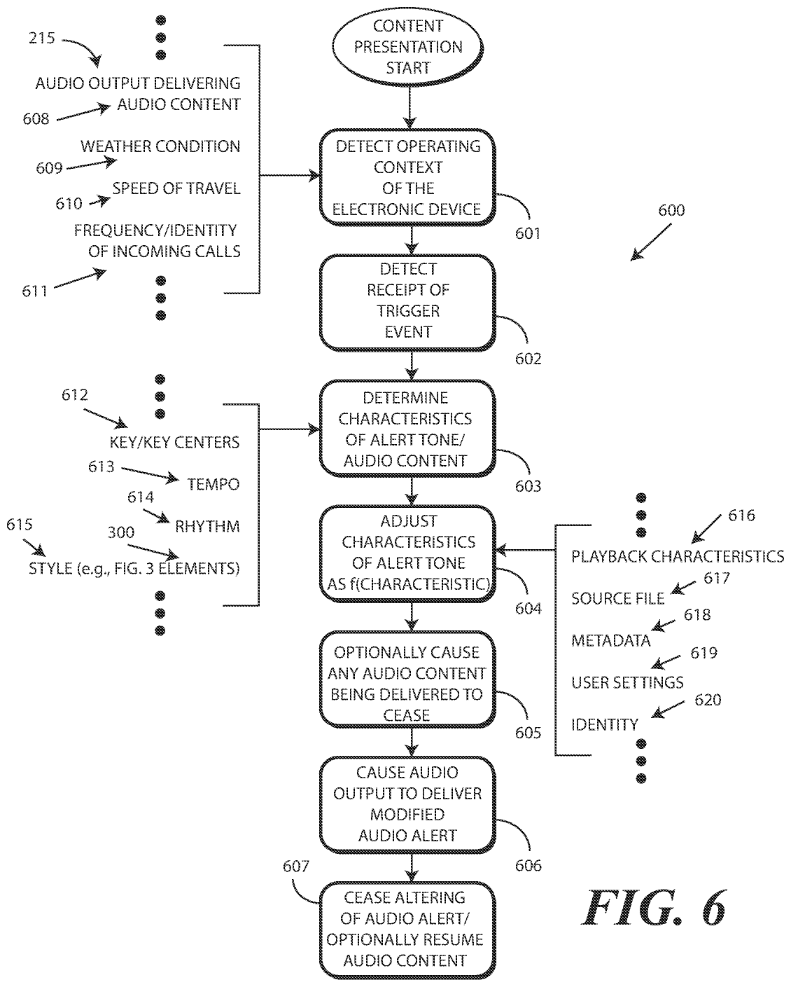

Turning now to FIG. 5, illustrated therein is a simplified diagram of the electronic device 200 combined with a signal flow illustrating how embodiments of the disclosure can function using the factor database (218) of FIG. 4 and/or the audible characteristics (300) of FIG. 3. As described above with reference to FIG. 2, in one or more embodiments the electronic device 200 comprises an audio output 215 and one or more processors 207 operable with the audio output 215. In the illustrative embodiment of FIG. 5, the electronic device 200 also includes a memory 208 storing one or more audible alerts 501 comprising music clips that can be used to generate and/or output ringing tones, ringtones, ringers, alert notifications, or other sounds.

Initially, the one or more processors 207 receive an input 502 initiating music playback. This input 502 requesting delivery of the audio content can occur for any number of reasons. A user may launch a music player application operating on the one or more processors 207 for example. The user may launch a video player application or gaming application that generates the audio content as well. Other audio content delivery applications can be launched to initiate the delivery of the audio content to the environment of the electronic device, as will be obvious to those of ordinary skill in the art having the benefit of this disclosure.

The one or more processors 207 then retrieve 503 one or more music clips 504 from memory. These music clips 504 may be permanently stored in the memory 208, such as would be the case if the music clips 504 were songs that a user of the electronic device 200 owned and maintained in the memory 208 on a long-term basis. Alternatively, the music clips 504 may be temporarily stored in the memory 208, such as may be the case when the music clips 504 were being streamed from a streaming music, video, or television service. The one or more processors 207 then cause 505 the audio output 215 to deliver audio content defined by the music clips 504 to an environment of the electronic device 200.

The one or more processors 207 then detect 506 a trigger event 507 occurring while the audio output 215 delivers the audio content defined by the music clips to the environment of the electronic device 200. Examples of the trigger event 507 include an incoming call, an incoming message, an incoming notification, a change in an operating context of the electronic device 200, and so forth. The one or more processors 207 then optionally determine 508 one or more audible characteristics 509 associated with the audio content defined by the music clips 504.

Since the one or more processors 207 have detected 506 the trigger event 507, they then load 510 an audible alert 501 defined by one or more alert clips from the memory 208. In one or more embodiments, the one or more processors 207 then, in response to detecting 506 the trigger event occurring while the audio output 215 delivers the audio content defined by the music clips 504, adjust 511 one or more audible characteristics 512 of the audible alert 501 that are different from the audible characteristics 509 associated with the audio content defined by the music clips 504. In one or more embodiments, this adjustment 511 occurs prior to causing the audio output 215 to deliver the audible alert 501.

In one or more embodiments, the one or more processors 207 adjust 511 the audible characteristics 512 of the audible alert 501 to match the audible characteristics 509 of the audio content defined by the music clips 504. To do this, the one or more processors 207 can adjust any of the audible characteristics (300) defined above with reference to FIG. 3 so that they match the audible characteristics 509 of the audio content.

In other embodiments, the memory 208 can store one or more user defined settings 515 instructing how the audible characteristic 512 of the audible alert 501 should be adjusted. In one or more embodiments, the one or more processors 207 adjust 511 the audible characteristics 512 of the audible alert 501 as a function of the one or more user defined settings 515 stored in the memory 208.

In one or more embodiments, the one or more processors 207 then cause 513 the audio output 215 to stop playing the audio content. The one or more processors 207 then cause 514 the audio output 215 to deliver the audible alert 501 in response to detecting 506 the trigger event 507. Said differently, in one or more embodiments the one or more processors 207 cause 513 playback of the audio content defined by the music clips 504 to temporarily cease while causing 514 the audio output 215 to deliver the audible alert 501. Thereafter, the one or more processors 207 can cause the audio output 215 to resume delivering the audio content to the environment of the electronic device 200.

Turning now to FIG. 6, illustrated therein is one explanatory method 600 in accordance with one or more embodiments of the disclosure. The method 600 of FIG. 6 functions to adjust one or more audible characteristics of an audible alert as a function of one or more input factors, examples of which include to match audio content being delivered by an audio output, an operating context of the electronic device, or other factors.

At step 601, the method 600 comprises detecting, by one or more processors of an electronic device, an operating context of the electronic device. The operating context can take different forms. Illustrating by example, in one or more embodiments the operating context comprises an audio output 215 delivering audio content 608 to an environment of the electronic device. In other embodiments, the operating context comprises a weather condition 609 occurring in an environment of the electronic device. In still other embodiments, the operating context detected at step 601 comprises a velocity of movement 610 of the electronic device.

In other embodiments, the operating context detected at step 601 comprises a recurrence of incoming calls 611 from a single source being received by a communication device of the electronic device. Step 601 can also comprise determining an identity of a source if incoming calls 611 as well. Other examples of operating contexts will be obvious to those of ordinary skill in the art having the benefit of this disclosure.

At step 602, the method 600 detects a trigger event occurring. In one or more embodiments, step 602 comprises detecting a trigger event while the operating context detected at step 601 is occurring. Thus, step 602 can comprise detecting, with one or more processors of an electronic device, a trigger event triggering an audible alert while the audio content is being delivered by an audio output of the electronic device.

At step 603, the method 600 determines one or more audible characteristics of the audible alert triggered by the trigger event detected at step 602. Step 603 can optionally, where the operating context of the electronic device comprises an audio output delivering audio content to an environment of the electronic device, comprise determining one or more audible characteristics of the audio content as well. Examples of these audible characteristics include the key or key centers 612, the tempo 613, the rhythm 614, and the style 615. Any of the audible characteristics 300 described above in FIG. 3 can be determined at step 603 as well.

In one or more embodiments, where the operating context of the electronic device comprises an audio output delivering audio content to an environment of the electronic device, step 603 further comprises determining whether there is a mismatch between at least one audible characteristic of the audible alert and at least one other audible characteristic of the audio content being delivered by the audio output. In one or more embodiments, step 603 comprises obtaining one or more audible characteristics associated with the audio alert from metadata associated with the audio alert.

At step 604, the method 600 alters one or more audible characteristics of the audible alert. This alteration can take many forms. Illustrating by example, in one or more embodiments step 604 comprises altering or adjusting the playback characteristics 616 of the audible characteristics of the audible alert. In other embodiments, step 604 comprises altering or adjusting a source file 617 of the audible alert to adjust and/or alter the audible characteristics of the audible alert.

In still other embodiments, step 604 comprises altering or adjusting the metadata 618 of the audible alert to adjust and/or alter the audible characteristics of the audible alert. As noted above, where a user interface of an electronic device receives one or more user settings 619 identifying how the source file 617 of the audible alert or the playback characteristics 616 of the audible alert should be altered, these user settings 619 can be employed to make the adjustment as well.

In one or more embodiments, where the operating context detected at step 601 comprises an identity 620 of a source of incoming calls 611, the altering occurring at step 604 can be a function of that identity. Illustrating by example, when the identity 620 of the source is a first identity, the altering of step 604 may result in a first altered audio alert; By contrast, when the identity 620 of the source is a second identity, the altering of step 604 may result in a second altered audio alert that is different from the first altered audio alert, and so forth.

In one or more embodiments, where the operating context of the electronic device detected at step 601 comprises an audio output delivering audio content to an environment of the electronic device, step 604 comprises adjusting one or more of a source file of the audio alert or a playback characteristic of the audio alert to eliminate the mismatch between audible characteristics of the audio content being delivered by the audio output and other audible characteristics of the audible alert.

At step 605, where the operating context of the electronic device detected at step 601 comprises an audio output delivering audio content to an environment of the electronic device, the method 600 optionally ceases delivery of that audio content. At step 606, the method 600 delivers the altered audible alert using the audio output. Once the altered audible alert has been delivered, step 607 can comprise ceasing the adjusting or altering initiated at step 604 and, where the operating context of the electronic device detected at step 601 comprises an audio output delivering audio content to an environment of the electronic device, causing the audio output to resume delivery of the audio content to the environment.

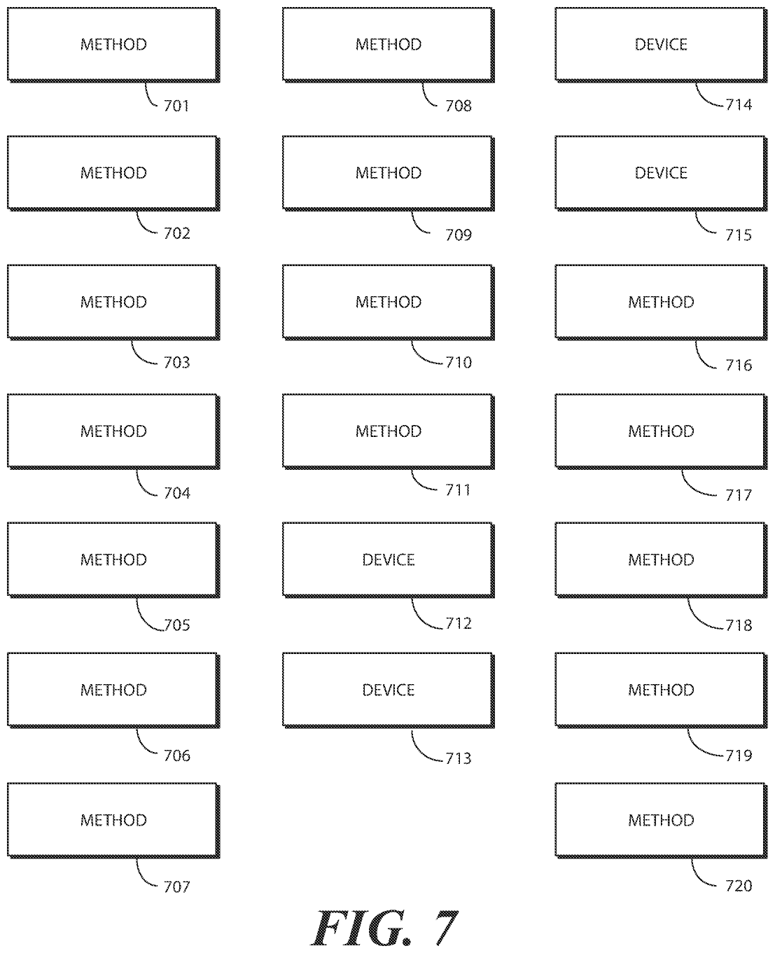

Turning now to FIG. 7, illustrated therein are various embodiments of the disclosure. The embodiments of FIG. 7 are shown as labeled boxes in FIG. 7 due to the fact that the individual components of these embodiments have been illustrated in detail in FIGS. 1-6, which precede FIG. 7. Accordingly, since these items have previously been illustrated and described, their repeated illustration is no longer essential for a proper understanding of these embodiments. Thus, the embodiments are shown as labeled boxes.

At 701, a method in an electronic device comprises detecting, with one or more processors, an event triggering an audio alert while audio content is being delivered by an audio output of the electronic device. At 701, the method comprises determining, by the one or more processors, a mismatch between at least one audible characteristic of the audio alert and at least one other audible characteristic of the audio content.

At 701, the method comprises adjusting, by the one or more processors, one or more of a source file of the audio alert or a playback characteristic of the audio alert to eliminate the mismatch. At 701, the method comprises delivering, by the audio output, the audio alert.

At 702, the adjusting of 701 results in a key of the audio alert being changed to match another key of the audio content. At 703, the adjusting of 702 results in a plurality of key centers of the audio alert being changed to match another plurality of key centers of the audio content.

At 704, the adjusting of 701 results in a tempo of the audio alert being changed to match another tempo of the audio content. At 705, the adjusting of 701 results in a style of the audio alert being changed to match another style of the audio content. At 706, the adjusting of 701 results in a rhythm of the audio alert being changed to match another rhythm of the audio content.

At 707, the method of 701 further comprises ceasing delivery of the audio content while the audio alert is being delivered. At 708, the method of 701 further comprises ceasing the adjusting when delivery of the audio content ceases.

At 709, the determining of 701 comprises obtaining, by the one or more processors, one or more audible characteristics associated with the audio alert from metadata associated with the audio alert. At 710, the adjusting of 709 comprises changing the metadata associated with the audio alert to eliminate the mismatch. At 710, the method of 710 further comprises receiving, at a user interface of the electronic device, one or more user settings identifying how the one or more of the source file of the audio alert or the playback characteristic of the audio alert should be adjusted to eliminate the mismatch.

At 712, an electronic device comprises an audio output. At 712, the electronic device comprises one or more processors operable with the audio output. At 712, in response to the one or more processors detecting a trigger event occurring while the audio output delivers audible content, the one or more processors adjust an audio characteristic of an audio alert that is different from another audio characteristic of the audio content prior to causing the audio output to deliver the audio alert.

At 713, the one or more processors of 712 adjust the audio characteristic to match another audio characteristic. At 713, the one or more processors further cause the audio output to deliver the audio alert in response to detecting the trigger event.

At 714, the one or more processors of 713 cause playback of the audio content to temporarily cease while causing the audio output to deliver the audio alert. At 715, the electronic device of 712 further comprises a memory operable with the one or more processors. At 715, the one or more processors adjust the audio characteristic of the audio alert as a function of one or more user-defined settings stored in a memory of the electronic device.

At 716, a method in an electronic device comprises detecting, by one or more processors of the electronic device, an operating context of the electronic device. At 716, the method comprises altering, by the one or more processors, one or more of a source file of an audio alert or a playback characteristic of the audio alert as a function of the operating context. At 716, the method comprises delivering, by an audio output, the audio alert in response to detecting an audio output triggering event.

At 717, the operating context of 716 comprises a weather condition occurring within an environment of the electronic device. At 718, the operating context of 716 comprises a velocity of movement of the electronic device. At 719, the operating context of 716 comprises a recurrence of incoming calls from a single source being received by a communication device of the electronic device.

At 720, the operating context of 716 comprises an identity of a source of an incoming call being received by a communication device of the electronic device. At 720, when the identity of the source is a first identity the altering results in a first altered audio alert. At 720, when the identity of the source is a second identity the altering results in a second altered audio alert that is different from the first altered audio alert.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

What is claimed is:

1. A method in an electronic device, the method comprising:
detecting, with one or more processors, an event triggering an audio alert while audio content is being delivered by an audio output of the electronic device;
determining, by the one or more processors, a mismatch between at least one audible characteristic of the audio alert and at least one other audible characteristic of the audio content;
adjusting, by the one or more processors, one or more of a source file of the audio alert or a playback characteristic of the audio alert to eliminate the mismatch; and
delivering, by the audio output, the audio alert.

2. The method of claim 1, wherein the adjusting results in a key of the audio alert being changed to match another key of the audio content.

3. The method of claim 2, wherein the adjusting results in a plurality of key centers of the audio alert being changed to match another plurality of key centers of the audio content.

4. The method of claim 1, wherein the adjusting results in a tempo of the audio alert being changed to match another tempo of the audio content.

5. The method of claim 1, wherein the adjusting results in a style of the audio alert being changed to match another style of the audio content.

6. The method of claim 1, wherein the adjusting results in a rhythm of the audio alert being changed to match another rhythm of the audio content.

7. The method of claim 1, further comprising ceasing delivery of the audio content while the audio alert is being delivered.

8. The method of claim 1, further comprising ceasing the adjusting when delivery of the audio content ceases.

9. The method of claim 1, wherein the determining comprises obtaining, by the one or more processors, one or more audible characteristics associated with the audio alert from metadata associated with the audio alert.

10. The method of claim 9, wherein the adjusting comprises changing the metadata associated with the audio alert to eliminate the mismatch.

11. The method of claim 10, further comprising receiving, at a user interface of the electronic device, one or more user settings identifying how the one or more of the source file of the audio alert or the playback characteristic of the audio alert should be adjusted to eliminate the mismatch.

12. An electronic device, comprising:
an audio output; and
one or more processors operable with the audio output;
wherein, in response to the one or more processors detecting a trigger event occurring while the audio output delivers audio content, the one or more processors adjust an audio characteristic of an audio alert that is different from another audio characteristic of the audio content prior to causing the audio output to deliver the audio alert.

13. The electronic device of claim 12, wherein:
the one or more processors adjust the audio characteristic to match the another audio characteristic; and
the one or more processors further cause the audio output to deliver the audio alert in response to detecting the trigger event.

14. The electronic device of claim 13, wherein the one or more processors cause playback of the audio content to temporarily cease while causing the audio output to deliver the audio alert.

15. The electronic device of claim 12, further comprising a memory operable with the one or more processors, wherein the one or more processors adjust the audio characteristic of the audio alert as a function of one or more user-defined settings stored in a memory of the electronic device.

16. A method in an electronic device, the method comprising:
detecting, by one or more processors of the electronic device, an operating context of the electronic device;
altering, by the one or more processors, one or more of a source file of an audio alert or a playback characteristic of the audio alert as a function of the operating context; and
delivering, by an audio output, the audio alert in response to detecting an audio output triggering event.

17. The method of claim 16, the operating context comprising a weather condition occurring within an environment of the electronic device.

18. The method of claim 16, the operating context comprising a velocity of movement of the electronic device.

19. The method of claim 16, the operating context comprising a recurrence of incoming calls from a single source being received by a communication device of the electronic device.

20. The method of claim 16, the operating context comprising an identity of a source of an incoming call being received by a communication device of the electronic device, wherein:
when the identity of the source is a first identity the altering results in a first altered audio alert; and
when the identity of the source is a second identity the altering results in a second altered audio alert that is different from the first altered audio alert.
